(19) United States
(12) Patent Application Publication
(10) Pub. No.: US 2024/0018010 A1
(43) Pub. Date: Jan. 18, 2024

(54) AMORPHOUS TUNGSTIC ACID FUSION AND TUNGSTEN OXIDE PREPARED USING SAME

(71) Applicant: BESTR CO., LTD., Incheon (KR)

(72) Inventors: Jeong Min SHIN, Incheon (KR); Jong In NA, Incheon (KR)

(73) Assignee: BESTR CO., LTD., Incheon (KR)

(21) Appl. No.: 18/265,099

(22) PCT Filed: Dec. 2, 2020
(86) PCT No.: PCT/KR2020/017467

§ 371 Date: Jun. 2, 2023

(51) Int. Cl. C01G 41/02; C01B 32/949; B22F 9/20; C01G 41/00

(52) U.S. Cl. CPC C01G 41/02; C01B 32/949; B22F 9/20; C01G 41/00; C01P 2004/45; C01P 2004/50; C01P 2004/54; C01P 2004/61; C01P 2004/32; C01P 2004/10; C01P 2004/51; C01P 2002/02; C01P 2002/74

(57) ABSTRACT

The present invention provides an amorphous tungstic acid fusion formed by agglomerating primary particles of tungstic acid, wherein the amorphous tungstic acid fusion has a grape-bunch-shaped structure formed therein as the primary particles of tungstic acid are interconnected. According to one embodiment of the present invention, eco-friendly and low-cost process technology can be provided that attains a reduction in process cost and a significant decrease in air and water pollutant emissions by not proceeding with an ATP process.

### TECHNICAL FIELD

The present invention relates to a tungstic acid fusion prepared by a wet process, tungsten oxide and tungsten powder prepared using the same, and more specifically, to a tungstic acid fusion formed by a wet process.

### BACKGROUND ART

Due to the development of high-tech industries, the development of the 4th industry, and an increase in demand for the environment, in addition to increased tungsten amount used in tool and mold fields, which are the largest demand for tungsten, the tungsten amount used has been rapidly increased even in the fields of semiconductor special gases, SCR catalysts, rolling parts, vibration motors, space aviation parts, thin films, and functional ceramics.

Most of the rapidly increasing tungsten demands are for tungsten compounds (WF₆ gas, cermet, etc.) and tungsten-containing composite materials (SCR catalyst, vibration motors, etc.), and the difficulty of tungsten recycling technology is increasing.

Tungsten materials mainly used include tungsten oxide (WO₃), tungsten powder (W), and tungsten carbide powder (WC).

Previously developed tungsten recycling technologies include a dry method and a wet method. In the dry method, WC is mainly prepared through several stages of heat treatment of tungsten tools, but it is difficult to be applied to waste with impurities and has limitations in controlling the purity and particle size of WC, which is a recycled product.

On the other hand, the wet process includes a preparing process of ammonium para tungstate (APT: (NH₄)₁₀W₁₂O₄₁·5H₂O). The APT preparing process is a process of forming and crystallizing a tungsten compound using ammonia, and in order to discharge ammonia gas generated in this process, treatment facilities must be built to meet atmospheric environmental standards. This has a problem in that the manufacturing cost of a tungsten material is greatly increased.

Accordingly, the present inventors introduced a novel process capable of replacing the APT process, which was a limitation of the wet method, to prepare high-purity amorphous tungstic acid (H₂WO₄) that may be used as a raw material for various tungsten materials, and then completed the present invention.

### DISCLOSURE

### Technical Problem

The present invention has been made to solve the above problems, and one embodiment of the present invention is to provide an amorphous tungstic acid fusion formed by agglomerating primary particles of tungstic acid.

In addition, another embodiment of the present invention is to provide a tungsten oxide prepared by calcining amorphous tungstic acid fusion powder.

In addition, yet another embodiment of the present invention is to provide a tungsten powder prepared by reducing amorphous tungstic acid fusion powder.

In addition, still another embodiment of the present invention is to provide a tungsten carbide powder prepared by carburizing amorphous tungstic acid fusion powder.

However, technical objects to be achieved in the present invention are not limited to the aforementioned objects, and other technical objects not described above will be apparently understood to those skilled in the art from the following disclosure of the present invention.

### Technical Solution

As a technical means for achieving the above-mentioned technical problem, an aspect of the present invention provides an amorphous tungstic acid fusion formed by agglomerating primary particles of tungstic acid, in which the amorphous tungstic acid fusion has a grape-bunch-shaped structure formed therein as the primary particles of tungstic acid are interconnected.

The shape of the primary particles of tungstic acid may be spherical, acicular, or a combination thereof.

The primary particles of tungstic acid may be spherical particles having a diameter of 0.01 to 2.0 μm.

The primary particles of tungstic acid may be acicular particles having a length (L) of 0.01 to 1.8 μm, and an aspect ratio (L/D) of 12 to 24.

The diameter of the amorphous tungstic acid fusion may be 30 μm or less.

The D₅₀ of the amorphous tungstic acid fusion obtained by particle size distribution measured by a laser diffraction scattering particle size distribution measuring method may be 5 to 12 μm.

The standard deviation of the diameter of the amorphous tungstic acid fusion may be 1.5 to 7 μm.

At least 80% or more of the primary particles of tungstic acid may be agglomerated by fusion-binding at least 5 or more particles to each other.

The primary particles of tungstic acid may consist of acicular particles and spherical particles, and the primary particles of tungstic acid may have a ratio of (weight of acicular particles):(weight of spherical particles) of 1:0.3 to 3.

Another aspect of the present invention provides a method for preparing an amorphous tungstic acid fusion including: adding a first additive containing an ammonium compound to a tungstate aqueous solution; injecting an acidic solution into the tungstate aqueous solution; and adding a second additive containing at least one of hydrogen peroxide and hydrofluoric acid to the aqueous solution, after injecting the acidic solution, in which the specific gravity of the tungstate aqueous solution is greater than 1.01 and less than 1.50, and 20 to 80 ml of the acidic solution is injected per 100 ml of the tungstate aqueous solution, 1 to 10 g of the first additive is added per 100 ml of the tungstate aqueous solution, 1 to 20 ml of the second additive is added per 100 ml of the tungstate aqueous solution, the amorphous tungstic acid fusion has a grape-bunch-shaped structure in which the primary particles of tungstic acid are interconnected, and the shape of the primary particles of tungstic acid is spherical, acicular, or a combination thereof.

The shape of the primary particles of tungstic acid may be acicular, or a combination of acicular and spherical shapes.

Yet another aspect of the present invention provides a tungsten oxide prepared by calcining the amorphous tungstic acid fusion powder.

Still another aspect of the present invention provides a tungsten powder prepared by reducing the amorphous tungstic acid fusion powder.

Still yet another aspect of the present invention provides a tungsten carbide powder prepared by carburizing the amorphous tungstic acid fusion powder.

### Advantageous Effects

According to an embodiment of the present invention, it is possible to provide an eco-friendly and low-cost process technology that reduces process cost and significantly reduces air and water pollutant emissions by not performing an APT process.

In addition, according to an embodiment of the present invention, it is possible to provide a preparing process of a tungsten material that is easily commercialized without requiring the development of special equipment and devices.

It should be understood that the effects of the present invention are not limited to the effects, but include all effects that may be deduced from the detailed description of the present invention or configurations of the present invention described in appended claims.

### DESCRIPTION OF DRAWINGS

FIG. 1 is a flowchart illustrating a method for preparing an amorphous tungstic acid fusion over time according to an embodiment of the present invention.

FIG. 2 is a flowchart illustrating steps of the method for preparing the amorphous tungstic acid fusion over time in more detail according to an embodiment of the present invention.

FIG. 3 illustrates a comparison between a conventional SEM image (left) of a tungstic acid powder and a SEM image (right) of a tungstic acid fusion powder according to an embodiment of the present invention.

FIGS. 4 to 6 show SEM images of examples of tungstic acid fusions prepared according to an embodiment of the present invention.

FIGS. 7 to 9 show XRD peak results of examples of tungstic acid fusions prepared according to an embodiment of the present invention.

FIGS. 10 to 12 show particle size distribution analysis results of examples of tungstic acid fusions prepared according to an embodiment of the present invention.

### MODES OF THE INVENTION

Hereinafter, the present invention will be described in more detail. However, the present invention may be embodied in various different forms, and the present invention is not limited by embodiments described herein, and the present invention will be only defined by claims to be described below.

In addition, terms used in the present invention are used only to describe specific embodiments, and are not intended to limit the present invention. The singular expression includes the plural expression unless the context clearly dictates otherwise. Throughout the present specification, unless explicitly described to the contrary, ‘comprising’ a certain component means further comprising another component other than excluding the other component.

A first aspect of the present invention provides an amorphous tungstic acid fusion formed by agglomerating primary particles of tungstic acid, in which the amorphous tungstic acid fusion has a grape-bunch-shaped structure formed therein as the primary particles of tungstic acid are interconnected.

Hereinafter, the amorphous tungstic acid fusion according to the first aspect of the present invention will be described in detail.

In one embodiment of the present invention, the amorphous tungstic acid fusion may have a grape-bunch-shaped structure formed therein as the primary particles of tungstic acid are interconnected. In addition, the shape of the primary particles of tungstic acid may be spherical, acicular, or a combination thereof.

In one embodiment of the present invention, when the shape of the primary particles of tungstic acid is spherical, the shape of the primary particles may become a grape-bunch-shaped tungstic acid fusion in which the primary particles are interconnected while existing independently one by one. In one embodiment of the present invention, the primary particles of tungstic acid may be spherical particles having a diameter of 0.01 to 2.0 μm. Preferably, the primary particles of tungstic acid may have a diameter of 0.03 to 1.8 μm, and the diameter of the primary particles of tungstic acid may vary depending on process conditions. However, in the case of the diameter of more than 2.0 μm, when the prepared amorphous tungstic acid fusion is made as tungsten oxide, tungsten, or tungsten carbide through a subsequent process, the powder particles may become unnecessarily enlarged. In the case of the diameter of less than 0.01 μm, there is a problem that the formation of the grape-bunch-shaped structure is not properly observed, and agglomeration is more likely to occur.

In one embodiment of the present invention, when the shape of the primary particles of tungstic acid is acicular, the primary particles of tungstic acid may be acicular particles having a length (L) of 0.01 to 1.8 μm and an aspect ratio (L/D) of 12 to 24. Preferably, the primary particles of tungstic acid may have a length (L) of 0.1 to 1.5 μm and an aspect ratio of 15 to 20. When the primary particles of tungstic acid satisfy a length (L) of 0.01 to 1.8 μm and an aspect ratio of 12 to 24, as compared to conventional amorphous tungstic acid powder, the primary particles of tungstic acid may have a grape-bunch-shaped structure in which the shape of the tungstic acid fusion is formalized. In the case of the tungstic acid fusion prepared by one embodiment of the present invention, when the tungstic acid fusion is formed of only primary particles having the acicular structure, the tungstic acid fusion is relatively well crystallized and may have an interconnected and spread shape.

In one embodiment of the present invention, the shape of the primary particles of tungstic acid may also be a combination of a spherical shape and an acicular shape. In this case, the diameter of the spherical primary particles of tungstic acid may satisfy the above range, and the length (L) and aspect ratio values of the acicular primary particles of tungstic acid may also satisfy the aforementioned range. In one embodiment of the present invention, the primary particles of tungstic acid may have a ratio of (weight of acicular particles):(weight of spherical particles) of 1:0.3 to 3, preferably 1:0.8 to 2. By satisfying the above-mentioned range, it is possible to obtain tungstic acid fusion particles having appropriately controlled crystallinity.

The tungstic acid fusion prepared according to one embodiment of the present invention may have crystallinity smaller than that of a tungstic acid fusion having only an acicular structure, but may have crystallinity higher than that of a tungstic acid fusion consisting of only spherical primary particles, and may have a shape in which spherical and acicular particles are mixed and interconnected and spread.

In one embodiment of the present invention, at least 50% or more of the primary particles of tungstic acid may be agglomerated by fusion-binding at least three or more primary particles to each other. Preferably, in at least 80% or more of the primary particles of tungstic acid, at least 5 or more primary particles may be fusion-bound to each other. By satisfying the above-mentioned range, it is possible to form a tungstic acid fusion having a grape-bunch-shaped structure like a bunch of grapes while each primary particle exists independently.

In one embodiment of the present invention, the particle characteristics of the amorphous tungstic acid fusion may be measured by X-ray diffraction (XRD). Through data such as positions, areas, intensities, and full widths at half maximum (FWHM) of peaks, the type, crystallinity, and grain distribution of the tungstic acid fusion may be analyzed. The “amorphous tungstic acid fusion” includes all tungstic acid fusions having a relatively low crystallinity, and as described below, the crystallinity may be adjusted by adjusting the shape of the primary particles of tungstic acid formed by the preparing method according to an embodiment of the present invention.

In one embodiment of the present invention, the diameter of the amorphous tungstic acid fusion may be 30 μm or less, preferably 25 μm. Although described below in detail, in the case of the tungstic acid fusion according to an exemplary embodiment of the present invention, it is possible to prepare a tungstic acid fusion capable of properly controlling the particle size while having a formalized particle shape by omitting an APT process and adding a first additive containing an ammonium compound and a second additive containing at least one of hydrogen peroxide and hydrofluoric acid, respectively, before and after injecting an acidic solution to a tungstate aqueous solution.

The D₅₀ of the amorphous tungstic acid fusion according to a particle size distribution measured by a laser diffraction scattering particle size distribution method may be 5 to 16 μm, preferably 5 to 12 μm. More preferably, when the shape of the primary particles of tungstic acid is spherical, the D₅₀ of the amorphous tungstic acid fusion may be 7 to 10 μm. When the shape of the primary particles of tungstic acid is acicular, the D₅₀ of the amorphous tungstic acid fusion may be 8.5 to 14 μm. When the shape of the primary particles of tungstic acid is a combination of acicular and spherical shapes, the D₅₀ of the amorphous tungstic acid fusion may be 6.5 to 9 μm.

In one embodiment of the present invention, the standard deviation of the diameter of the amorphous tungstic acid fusion may be 1.5 to 7 μm, preferably 1.5 to 6.5 μm. The standard deviation may vary according to the shape of the primary particles of tungstic acid. Preferably, when the shape of the primary particles of tungstic acid is spherical, the standard deviation of the diameter of the amorphous tungstic acid fusion may be 2 to 4 μm, when the shape of the primary particles of tungstic acid is acicular, the standard deviation of the diameter of the amorphous tungstic acid fusion may be 4 to 7 μm, and when the shape of the primary particles of tungstic acid is a combination of acicular and spherical shapes, the standard deviation of the diameter of the amorphous tungstic acid fusion may be 2 to 4 μm. When the standard deviation of the diameter of the amorphous tungstic acid fusion exceeds 7 μm, it will be difficult to be manufactured by a process in which the shape or particle size is properly controlled, and when preparing tungsten oxide, tungsten, or tungsten carbide through subsequent processes, the grain size deviation becomes larger, making it difficult to manufacture uniform powder.

A second aspect of the present invention provides a method for preparing an amorphous tungstic acid fusion including:
adding a first additive containing an ammonium compound to a tungstate aqueous solution; injecting an acidic solution into the tungstate aqueous solution; and adding a second additive containing at least one of hydrogen peroxide and hydrofluoric acid to the aqueous solution after injecting the acidic solution. The specific gravity of the tungstate aqueous solution is greater than 1.01 and less than 1.50, and 20 to 80 ml of the acidic solution is injected per 100 ml of the tungstate aqueous solution, 1 to 10 g of the first additive is added per 100 ml of the tungstate aqueous solution, 1 to 20 ml of the second additive is added per 100 ml of the tungstate aqueous solution, the amorphous tungstic acid fusion has a grape-bunch-shaped structure in which primary particles of tungstic acid are interconnected, and the shape of the primary particles of tungstic acid is spherical, acicular, or a combination thereof.

Detailed descriptions of portions overlapping with those of the first aspect of the present invention have been omitted, but the contents described for the first aspect of the present invention may be equally applied even if the description thereof has been omitted from the second aspect.

Hereinafter, a method for preparing an amorphous tungstic acid fusion according to the second aspect of the present invention will be described in detail with reference to the accompanying drawings.

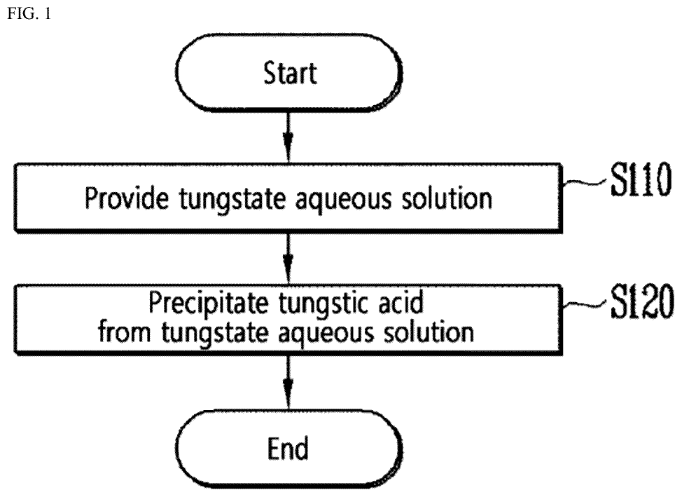

FIG. 1 is a flowchart illustrating a method for preparing an amorphous tungstic acid fusion over time according to an embodiment of the present invention.

As shown in FIG. 1, the method for preparing a tungsten oxide includes providing a tungstate aqueous solution (S110), and precipitating tungstic acid from the tungstate aqueous solution (S120).

The method for preparing the amorphous tungstic acid fusion according to an embodiment of the present invention may correspond to a wet process by precipitating tungstic acid (H₂WO₄) from the tungstate aqueous solution. When tungsten oxide is prepared by the wet process, an ammonium para tungstate (APT) preparing process is usually included, but according to an embodiment of the present invention, the APT preparing process may be omitted. When the APT preparing process is involved, several disadvantages are involved due to the characteristics of the preparing process. In particular, in the APT preparing process, since a tungsten compound is formed and crystallized using ammonia, the evaporation/concentration process performed in the crystallization step requires a lot of energy and generates a large amount of ammonia gas. In order to process ammonia gas, a lot of cost occurs, and the domestic tungsten production is more difficult. The reason why the APT preparing process is required despite the high cost is that tungstic acid powder forms fine and imperfect-shaped particles in a process of substituting tungstate with tungstic acid. The tungstic acid particles formed in the substituting process are further broken into smaller pieces through a subsequent repeated washing process, but the finer and more irregular the sizes of the tungstic acid particles, the more difficult filtering and washing processes to be performed later. Here, the APT preparing process may increase the size of the tungstic acid particles and make the shape of the tungstic acid particles uniform, so that the tungstic acid particles may be smoothly handled in subsequent processing including filtering and washing processes.

In one embodiment of the present invention, the method for preparing the amorphous tungstic acid fusion controls the size and shape of formed particles using additives in the process of substituting tungstate with tungstic acid. It may be seen that the particle size may be as large as the tungstic acid particles by the APT preparing process, and the particle shape forms a grape-bunch-shaped structure in which the primary particles of tungstic acid are interconnected so as not to be easily broken even during the repeated washing process.

In one embodiment of the present invention, the additives may be a first additive of an ammonium compound and a second additive including at least one of hydrogen peroxide and hydrofluoric acid. Process efficiency in subsequent filtering and washing steps may be enhanced by giving dissolving, agglomerating and dispersing effects to the precipitated tungstic acid powder using the additives in the substituting process to create uniformly shaped particles of a certain size or more.

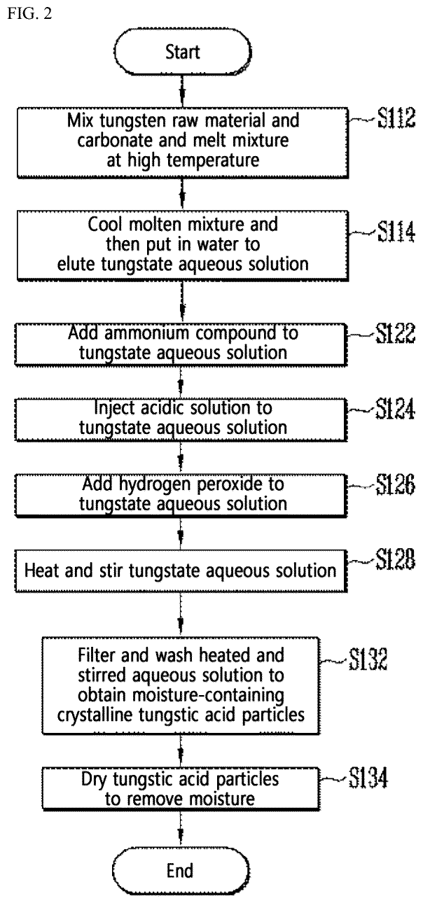

Hereinafter, the method will be described in more detail with reference to FIG. 2.

FIG. 2 is a flowchart showing steps S110 and S120 of the method for preparing the amorphous tungstic acid fusion according to an embodiment of the present invention in more detail over time.

As shown in FIG. 2, in one embodiment of the present invention, step S110 may include mixing a tungsten raw material and carbonate and melting the mixture at a high temperature (S112), and cooling the molten mixture and then putting the mixture into water to elute a tungstate aqueous solution (S114).

In one embodiment of the present invention, the tungsten raw material is a raw material containing tungsten and may include ore, sludge, scrap, and the like. The tungsten raw material may be pulverized and oxidized before mixing with the carbonate as a pretreatment step for more efficient operation of step S112.

Specifically, among the tungsten raw materials, the ore is repeatedly crushed and sorted, and the sludge is dried and crushed to remove oil present in the sludge and make oxidized grains of an appropriate size. The scrap is made into oxidized grains of an appropriate size through repeated processes of oxidation and grinding. At this time, the oxidation temperature may be 800 to 1000° C.

The carbonate is mixed with the tungsten raw material prepared above and melted at a high temperature (S112). At a high temperatures, carbonate and tungsten are bound to form a tungsten compound, and at this time, the tungsten compound becomes water-soluble. In one embodiment of the present invention, the carbonate may be sodium carbonate (Na₂CO₃). That is, in step S112, water-soluble sodium tungstate (Na₂WO₄) is prepared by mixing the tungsten raw material and sodium carbonate in an appropriate ratio and melting the mixture at a high temperature.

In one embodiment of the present invention, the tungsten raw material and sodium carbonate may be mixed in a ratio of 1:0.4 to 1. When the ratio of sodium carbonate to the tungsten raw material is less than 0.4, the amount of sodium carbonate is relatively too low to the amount of tungsten. Therefore, it is disadvantageous that there may be residual tungsten that is not bound as sodium tungstate (Na₂WO₄) because it does not reach an equivalent weight that may be combined with sodium and tungsten. When the ratio exceeds 1, since sodium is also an impurity to be eventually removed, there is a disadvantage that the amount of removed impurities due to excessive addition in a subsequent process increases. Therefore, it is preferable that the ratio is 0.4 to 1.

In one embodiment of the present invention, the melting temperature of step S112 may be 800 to 1000° C. At this time, if the melting temperature is less than 800° C., there is a disadvantage that the melting temperature is not reached, so that the amount of tungsten which is not combined and molten increases, thereby reducing the recovery rate. If the melting temperature exceeds 1000° C., a lot of energy is unnecessarily consumed to increase production costs. Accordingly, the melting temperature is preferably selected from 800 to 1000° C.

Next, in one embodiment of the present invention, the molten mixture in step S112 is cooled and put into water to elute the tungstate aqueous solution (S114). The tungsten compound melted in step S112 is water-soluble, and other components (for example, cobalt, copper, nickel, alumina, etc.) of the tungsten raw material, which have a relatively weak binding force with carbonate, remain insoluble in water during the elution step, and thus, it is possible to selectively extract the tungstate aqueous solution in step S114. When the amount of eluting water is less than twice the weight of the tungsten raw material, tungsten is more likely to remain together in the residue that is not completely dissolved in water and remains insoluble in water. If the amount of eluting water exceeds 15 times, there is a problem that the amount of the acidic solution used to reach a certain pH may be increased in a subsequent substituting process, and fine powder is generated to deteriorate production efficiency. Therefore, it is appropriate to set the amount of eluting water to be 2 to 15 times the weight of the tungsten raw material.

In addition, in one embodiment of the present invention, the specific gravity of the tungstate aqueous solution may be greater than 1.01 and less than 1.50, preferably 1.05 to 1.40. As the specific gravity of the tungstate aqueous solution increases, the shape of the primary particles of tungstic acid may tend to be spherical. Accordingly, by controlling the specific gravity of the tungstate aqueous solution, the shape of the primary particles of tungstic acid may be controlled and the crystallinity of the amorphous tungstic acid fusion may be controlled.

The tungstate aqueous solution provided through the steps S112 to S114 is precipitated as tungstic acid through the following steps S122 to S128. Hereinafter, the method will be described in more detail with reference to FIG. 2.

In one embodiment of the present invention, step S120 may include adding an ammonium compound to a tungstate aqueous solution (S122); injecting an acidic solution into the tungstate aqueous solution (S124); adding hydrogen peroxide to the tungstate aqueous solution (S126); and heating and stirring the tungstate aqueous solution (S128).

Meanwhile, in one embodiment of the present invention, the ammonium compound and the hydrogen peroxide may be added after the acidic solution is injected, but the adding of the ammonium compound before injecting the acidic solution is advantageous in terms of forming particles with a more uniform distribution, and the adding of hydrogen peroxide after injecting the acidic solution is advantageous in that tungstic acid may be precipitated under the same pH conditions, enabling the production of powder with a more regular shape. Accordingly, an example in which the ammonium compound is added before injecting the acidic solution and the hydrogen peroxide is added after injecting the acidic solution will be described. In addition, according to one embodiment of the present invention, hydrofluoric acid (HF) may be added instead of hydrogen peroxide, but in the case of using hydrogen peroxide rather than hydrofluoric acid, the effect of recrystallization and agglomeration is excellent, and thus, an example of using hydrogen peroxide will be mainly described.

First, in one embodiment of the present invention, the ammonium compound as an additive may be added and dissolved in the tungstate aqueous solution provided in step S110 (S122). In order to distinguish the additive to be added in step S122 from the additive to be added in subsequent step S126, the ammonium compound in step S122 is referred to as a first additive, and the hydrogen peroxide in step S126 is referred to as a second additive.

In one embodiment of the present invention, the tungstate aqueous solution may be a sodium tungstate aqueous solution (Na₂WO₄ (aq)). Hereinafter, an example in which the tungstate aqueous solution is a sodium tungstate aqueous solution will be mainly described.

The ammonium compound according to one embodiment of the present invention is a water-soluble compound containing ammonium ions (NH4+), and may include at least one of ammonium chloride (NH₄Cl), ammonium nitrate (NH₄NO₃), ammonium carbonate ((NH₄)₂CO₃), ammonium bicarbonate (NH₄HCO₃), ammonium sulfate ((NH₄)₂SO₄), ammonium fluoride (NH₄F), ammonium oxalate ((NH₄)₂C₂O₄), ammonium acetate (NH₄CH₃CO₂), monoammonium phosphate (NH₄H₂PO₄), and diammonium phosphate ((NH₄)₂HPO₄). As described below, the first additive containing ammonium ions may act as a dispersant for tungstic acid precipitated from the sodium tungstate aqueous solution. The binding force of the ammonium ion (NH4⁺) of the ammonium compound is weaker than that of the sodium ion (Na⁺) to the tungstate ion (WO4⁻) of the sodium tungstate aqueous solution, so that the ammonium ion (NH4⁺) does not form a new compound with the tungstate ion (WO4⁻) in the sodium tungstate aqueous solution, and may stably serve as a dispersant in the sodium tungstate aqueous solution as described below. In one embodiment of the present invention, the ammonium compound may be added in an amount of 1 to 10 g per 100 ml of the sodium tungstate aqueous solution. When less than 1 g of the ammonium compound is added per 100 ml of the sodium tungstate aqueous solution, the effect as the dispersant is reduced and thus the agglomeration of particles may occur. When more than 10 g is added, as the amount of ammonium ions increases, ammonium ions, tungsten ions, and sodium ions may bind together, making it difficult to remove sodium in a subsequent process. In addition, unnecessary excessive addition causes an increase in production cost. Therefore, it is preferable to add 1 to 10 g of the ammonium compound per 100 ml of the sodium tungstate aqueous solution.

Next, in one embodiment of the present invention, the acidic solution may be injected into the tungstic acid aqueous solution in which the ammonium compound is dissolved (S124). The acidic solution may include at least one of hydrochloric acid (HCl), nitric acid (HNO₃) and sulfuric acid (H₂SO₄). The acidic solution lowers the pH of the sodium tungstate aqueous solution to make an environment in which tungstic acid may be precipitated from the sodium tungstate aqueous solution when the aqueous solution reaches a certain pH value. A certain pH value may be 1 to 2 or less. The acidic solution is added to the sodium tungstate aqueous solution to act as a substituting agent for substituting sodium ions (Na⁺) of the sodium tungstate with hydrogen ions (H⁺). That is, when the acidic solution is injected and the pH of the sodium tungstate aqueous solution reaches a certain value (e.g., 1 or less), in the aqueous solution, sodium ions of sodium tungstate are substituted with hydrogen ions, and water-insoluble tungstic acid is formed and begins to precipitate in the aqueous solution. 20 to 80 ml of the acidic solution may be injected per 100 ml of the sodium tungstate aqueous solution. If less than 20 ml of the acidic solution is injected per 100 ml of the sodium tungstate aqueous solution, a certain pH value (e.g., 1 to 2) at which tungstic acid is precipitated may not be reached, and sodium ions (Na⁺) and hydrogen ions (H⁺) may not reach an equivalent that may be substituted, resulting in a decrease in recovery rate. If more than 80 ml of the acidic solution is injected, there is a possibility that irregular particles may be generated under the influence of an excessively injected acidic solution, and the amount of solution to be handled in a subsequent process increases, resulting in a decrease in productivity. Accordingly, the acidic solution is preferably injected in the range of 20 to 80 ml per 100 ml of the sodium tungstate aqueous solution.

In one embodiment of the present invention, immediately after the acidic solution is injected, the acidic solution may be stirred to be well mixed in the sodium tungstate aqueous solution.

Next, in one embodiment of the present invention, hydrogen peroxide (H₂O₂) as the second additive is added to the tungstic acid aqueous solution into which the acidic solution is injected (S126). The hydrogen peroxide may act as a solubilizing agent for tungstic acid precipitated in the aqueous solution. As described above, when the pH of the aqueous solution is lowered below a certain value as the acidic solution is injected, insoluble tungstic acid begins to precipitate, and at this time, hydrogen peroxide dissolves the precipitated tungstic acid so that tungstic acid particles may be formed in a desired shape as described below. Meanwhile, since hydrofluoric acid may also dissolve tungstic acid precipitated in the sodium tungstate aqueous solution, according to another embodiment of the present invention, hydrofluoric acid may be added as the second additive. The second additive may be added in an amount of 1 to 20 ml per 100 ml of the sodium tungstate aqueous solution. If less than 1 ml of the second additive is added per 100 ml of the sodium tungstate aqueous solution, insoluble tungstic acid may be present, which may cause formation of irregular particles. If more than 20 ml of the second additive is added, it takes a long time to generate tungstic acid again after dissolution, and the addition of a lot of hydrogen peroxide may increase the pH, so that it is necessary to further inject the acidic solution to lower the pH. This reduces efficiency. Therefore, it is preferable to add 1 to 20 ml of the second additive per 100 ml of the sodium tungstate aqueous solution. In one embodiment of the present invention, when the second additive is added in an amount of more than 12 ml per 100 ml of the tungstate aqueous solution (e.g., sodium tungstate aqueous solution), a ratio at which the shape of the primary particles of tungstic acid to be precipitated is acicular may be increased. That is, as the content of the second additive is relatively high, the shape of the primary particles of tungstic acid may be acicular, or a combination of acicular and spherical shapes. Accordingly, by controlling the degree to which the second additive is added in a predetermined amount or more, the shape of the primary particles of tungstic acid may be controlled and the crystallinity of the amorphous tungstic acid fusion may be controlled.

In one embodiment of the present invention, the sodium tungstate aqueous solution into which the first additive, the substituting agent, and the second additive are added is heated and stirred (S128). At this time, the heating and stirring may proceed at a rate of 60 to 400 rpm for 1 to 6 hours in a temperature range of 30 to 75° C. If the heating temperature is lower than 30° C., the precipitation time becomes longer and it is difficult to expect uniform particle formation, and if the heating temperature is higher than 75° C., fine powder is formed, which makes the subsequent process difficult. If the heating and stirring proceeds for less than 1 hour, crystal formation may not occur because the time does not reach the reaction time for precipitation, and if the heating and stirring proceeds for more than 6 hours, all reactions have already been completed, so that it is not meaningful for reaction times of more than 6 hours. In addition, when the stirring rate is less than 60 rpm, it is difficult to apply the production process because it is difficult to meet the agglomeration phenomenon of the particles and uniform pH conditions, and when the stirring rate is more than 400 rpm, it is difficult to affect the formation of fine powder and secure the uniformity of the particles. Accordingly, it is preferred that the heating and stirring proceeds at a rate of 60 to 400 rpm for 1 to 6 hours in a temperature range of 30 to 75° C. As step S128 proceeds, the primary particles exist independently to generate tungstic acid fusion particles formed in a grape-bunch-shaped structure. Unlike particles prepared by applying a conventional wet process, the generated tungstic acid particles has improved breakage by having the regularity of the particles each formed to a certain size or more and thus are easily treated in subsequent filtering and washing steps to prepare a tungstic acid fusion without the existing APT preparing process.

In order to control the size and shape of the precipitated tungstic acid particles, the role of the additives added to the sodium tungstate aqueous solution will be described in more detail. As follows, in the aqueous solution, hydrogen peroxide plays a dissolving and agglomerating role, and an ammonium compound plays a dispersing role. When the pH of the sodium tungstate aqueous solution reaches a certain value by the acidic solution, insoluble tungstic acid begins to precipitate in the aqueous solution. At this time, hydrogen peroxide is added to dissolve insoluble tungstic acid. As described above, hydrofluoric acid may also be used instead of hydrogen peroxide.

In addition, the heating and stirring of the aqueous solution are performed under certain conditions and tungstic acid begins to precipitate again over time, but is subjected to a step of dissolving and re-precipitating tungstic acid generated irregularly until a low pH value (e.g., pH 1) at which tungstic acid is precipitated becomes in the sodium tungstate solution having a high pH value (e.g., pH 14) under various same conditions including the same pH section, which may be a recrystallization process for forming regular and shaped particles. Meanwhile, when tungstic acid is precipitated, the ammonium compound dissolved in the aqueous solution acts as a dispersant, and thus, the tungstic acid powders are precipitated in a dispersed state so as not to be excessively agglomerated with each other.

That is, as the tungstic acid powder is dissolved by hydrogen peroxide and undergoes a recrystallization process, the tungstic acid powders agglomerate with each other to form fusion particles of a certain size or more (dissolving and agglomerating role of hydrogen peroxide). At the same time, as the tungstic acid fusion particles formed in a certain size or more are dispersed so as not to agglomerate with each other by the surface activating effect of the ammonium compound (the dispersing role of the ammonium compound), the particles no longer agglomerate to maintain the shape. If the ammonium compound is not added, the tungstic acid particles formed to a certain size by hydrogen peroxide do not maintain the shape any longer and partially continue to agglomerate with each other to be deformed into new amorphous particles that extend irregularly horizontally or vertically. These amorphous particles are vulnerable to external impact in the repeated washing process which is the subsequent process. On the other hand, if hydrogen peroxide is not added, tungstic acid powders precipitated from the sodium tungstate aqueous solution may not be dissolved and agglomerate with each other to form one large lump. In short, the dissolving and agglomerating role of hydrogen peroxide and the dispersing role of ammonium compound are mutually complementary in the sodium tungstate aqueous solution, so that the precipitated tungstic acid powder may form tungstic acid fusion particles having formability of a grape-bunch-shaped structure in which the primary particles independently exist.

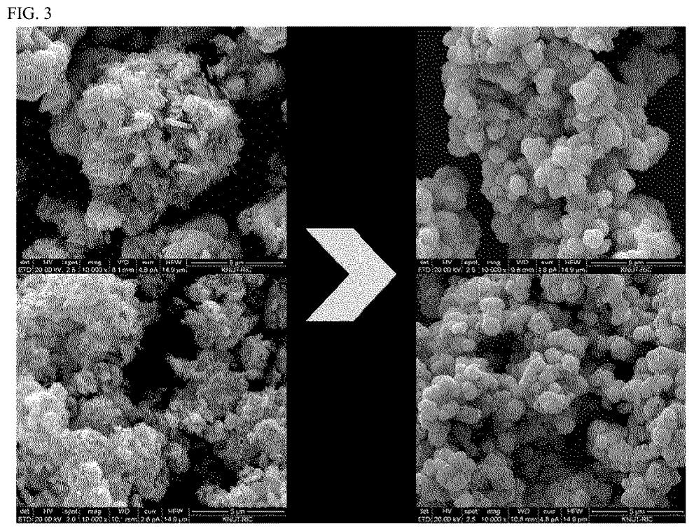

When the pH of the aqueous solution reaches a certain value (e.g., pH 1 or less) as the acidic solution, which is a substituting agent, is added to the sodium tungstate aqueous solution, tungstic acid begins to precipitate from the sodium tungstate aqueous solution, and at this time, the precipitated tungstic acid powder tends to amorphously agglomerate with each other (see the left side of FIG. 3).

Referring to the left side of FIG. 3, tungstic acid particles prepared according to a conventional wet process without the ammonium compound and hydrogen peroxide are shown. As shown on the left side of FIG. 3, the sizes of the particles formed by gathering the tungstic acid powder are amorphous and irregular, with some being horizontally long and others being vertically long. The particles are easily broken into small pieces in subsequent repeated filtrating and washing steps, making subsequent processing difficult.

However, when the ammonium compound and hydrogen peroxide are added to the sodium tungstate aqueous solution according to the method according to an embodiment of the present invention, the tungstic acid powder precipitated from the sodium tungstate aqueous solution is dissolved and agglomerated by hydrogen peroxide and dispersed by the ammonium compound, so that the precipitated tungstic acid powder is substantially uniformly agglomerated and dispersed to form particles having formability (see the right side of FIG. 3). As shown on the right side of FIG. 3, tungstic acid particles having a grape-bunch-shaped formability, which are separated one by one, are formed by the complementary action of the hydrogen peroxide and the ammonium compound in the tungstate aqueous solution. The tungstic acid fusion particles having the shape improve the breakage phenomenon due to repeated washing in the subsequent step and facilitate filtering and washing, so that it is possible to prepare tungsten oxide, tungsten powder, or tungsten carbide by a subsequent process immediately without an APT preparing process.

Subsequently, steps of preparing tungsten oxide using the tungstic acid obtained through the above-described steps S122 to S128 will be described.

As shown in FIG. 2, the method for preparing the tungstic acid fusion according to an embodiment of the present invention may include filtering and washing the heated and stirred aqueous solution to obtain moisture-containing crystalline tungstic acid particles (S132); and drying the tungstic acid particles to remove moisture (S134).

First, in one embodiment of the present invention, in step S132, the solution completed up to step S128 is filtered through a filtering device, and acid washing and distilled water washing are repeated. Through step S132, the moisture-containing crystalline tungstic acid particles may be obtained. The tungstic acid fusion particles according to one embodiment of the present invention may be smoothly and repeatedly washed because the breakage of the powder due to repeated washing is improved. For filtration, a filter paper may be used, and a hole size of the filter paper may be determined in consideration of an effective size of the tungstic acid particles. Preferably, since the size of the tungstic acid particles obtained according to one embodiment of the present invention may have a size of about 3 μm or more, a filter paper having a hole size of 3 μm or less may be selectively used.

In one embodiment of the present invention, the acidic solution used for acid washing may be the same as the substituting solution used in step S124. This is advantageous in terms of process efficiency. For example, at least one of hydrochloric acid (HCl), nitric acid (HNO₃), and sulfuric acid (H₂SO₄) may be used. The concentration of the acidic solution used for acid washing may be 1 to 10%. When the concentration of the acidic solution is less than 1%, the impurity removal effect is reduced, and when the concentration exceeds 10%, an increase in washing water in the distilled water washing process is caused, so that it is preferable that the concentration of the acidic solution is selected within the range of 1 to 10%. The acid washing and the distilled water washing may be repeatedly performed twice or more. If the number of acid washing and distilled water washing exceeds 5 times, the amount of distilled water used increases, the production cost increases, and the possibility of powder breakage increases, so that it is preferable not to exceed 5 times.

In one embodiment of the present invention, the moisture may be removed by drying the tungstic acid powder after washing in a dryer (S134). Through step S134, the moisture that has contained in the tungstic acid fusion particles is removed. At this time, it is appropriate that the drying temperature is 60 to 100° C. If the drying temperature is less than 60° C., the drying time is long and the drying efficiency is lowered, and if the drying temperature exceeds 100° C., agglomeration between the powders may occur, which is disadvantageous, so that it is appropriate that the drying temperature is selected in the range of 60 to 100° C.

A third aspect of the present invention provides a tungsten oxide prepared by calcining the amorphous tungstic acid fusion powder.

Detailed descriptions of portions overlapping with those of the first aspect and the second aspect of the present invention have been omitted, but the contents described for the first aspect and the second aspect of the present invention may be equally applied even if the description thereof has been omitted from the third aspect.

Hereinafter, the tungsten oxide according to the third aspect of the present invention will be described in detail.

In one embodiment of the present invention, for the calcination treatment, a calcination furnace may be used in an air or vacuum atmosphere. It is appropriate that the calcination temperature is 500 to 1000° C. and the calcination time is 1 to 6 hr. When the calcination temperature is less than 500° C. or the calcination time is less than 1 hr, a change in crystal structure from tungstic acid to tungsten oxide does not occur well, and when the calcination temperature exceeds 1000° C. or the calcination time exceeds 6 hr, the powder hardens and there is a problem in a subsequent process. Accordingly, it is preferred that the calcination temperature is selected in the range of 500 to 1000° C., and the calcination time is selected in the range of 1 to 6 hr.

A fourth aspect of the present invention provides a tungsten powder prepared by reducing the amorphous tungstic acid fusion powder.

Detailed descriptions of portions overlapping with those of the first aspect to the third aspect of the present invention have been omitted, but the contents described for the first aspect to the third aspect of the present invention may be equally applied even if the description thereof has been omitted from the fourth aspect.

In one embodiment of the present invention, the tungsten powder may be prepared by hydrogen reduction of the amorphous tungstic acid fusion powder. For reduction treatment, the temperature may be 900 and 1200° C. When the temperature is less than 900° C., a change from tungstic acid to tungsten is not well made, and when the reduction temperature exceeds 1200° C., the agglomeration phenomenon occurs between the particles of the powder and the particles are hardened, which causes a problem in the post-process. Accordingly, it is preferred that the reduction temperature is selected in the range of 900 to 1200° C.

A fifth aspect of the present invention provides a tungsten carbide powder prepared by mixing the amorphous tungstic acid fusion powder with carbon powder and carburizing the mixture.

Detailed descriptions of portions overlapping with those of the first aspect to the fourth aspect of the present invention have been omitted, but the contents described for the first aspect to the fourth aspect of the present invention may be equally applied even if the description thereof has been omitted from the fifth aspect.

In one embodiment of the present invention, for the carburizing treatment, the temperature may be 900 to 1300° C. When the temperature is less than 900° C., a change from tungstic acid to tungsten carbide is not well made, and when the reduction temperature exceeds 1300° C., the agglomeration phenomenon occurs between the particles of the powder and unnecessarily bulky powder may be formed and hardened, which causes a problem in the post-process. Accordingly, it is preferred that the carburizing temperature is selected in the range of 900 to 1300° C.

Hereinafter, Examples of the present invention will be described in detail so as to easily implement those skilled in the art. However, the present invention may be variously implemented and is not limited to the following Examples.

### Example 1. Preparation of Tungstic Acid Fusion

Sodium carbonate was mixed with a tungsten raw material powder made in an appropriate size at a weight ratio of 1:0.6, put in a container, charged into a box-type electric furnace, and then melted at a high temperature of 800° C. for 6 hours in an air atmosphere. Then, the melt was cooled to room temperature, put in water to dissolve only tungsten, and then filtered to prepare a sodium tungstate (Na₂WO₄) aqueous solution.

The ammonium compound was added to 300 ml of the prepared sodium tungstate aqueous solution and stirred and dissolved, and then added with 100 ml of the acidic solution and hydrogen peroxide (H₂O₂, 35%) according to Table 1 below, respectively, and reacted for about 6 hours while maintaining 45 to 50° C. and maintaining the stirring rate of about 100 rpm to precipitate tungstic acid (H₂WO₄).

Thereafter, in order to separate tungstic acid and the solution, a filter paper was laid on a filtering device and filtered. An acid washing solution (HCl, 3.5%) was made, and the filtrate was washed twice with the acid washing solution, washed three times with distilled water, and then dried in a dryer maintained at 85° C. to form a tungstic acid fusion.

TABLE 1

| | | Acidic | Dissolving agent | | |
|---|---|---|---|---|---|
| Tungstate | Dispersant | solution | (agglomerating | | |
| aqueous | (first | (substituting | agent, second | Reaction | Reaction |
| solution | additive) | agent) | additive) | temperature | time |
| 300 ml | NH₄Cl: 10 g | HNO₃: 100 ml | H₂O₂: 30 ml | 45 to 50° C. | 6 hr |
| (specific | | | | | |
| gravity 1.20) | | | | | |
| 300 ml | NH₄Cl: 10 g | HCl: 100 ml | H₂O₂: 30 ml | 45 to 50° C. | 6 hr |
| (specific | | | | | |
| gravity 1.20) | | | | | |
| 300 ml | NH₄Cl: 10 g | H₂SO₄: 100 ml | H₂O₂: 30 ml | 45 to 50° C. | 6 hr |
| (specific | | | | | |
| gravity 1.20) | | | | | |
| 300 ml | (NH₄)₂SO₄: 15 g | HNO₃: 100 ml | H₂O₂: 25 ml | 45 to 50° C. | 6 hr |
| (specific | | | | | |
| gravity 1.20) | | | | | |

### Example 2. Preparation of Tungstic Acid Fusion

A tungstic acid fusion was prepared in the same manner as in Example 1, except that the conditions were changed as shown in Table 2 below.

TABLE 2

| | | Acidic | | | |
|---|---|---|---|---|---|
| Tungstate | | solution | Dissolving agent | | |
| aqueous | | (substituting | (agglomerating | Reaction | Reaction |
| solution | Dispersant | agent) | agent) | temperature | time |
| 300 ml | NH₄Cl: 10 g | HNO₃: 100 ml | H₂O₂: 40 ml | 45 to 50° C. | 6 hr |
| (specific | | | | | |
| gravity 1.05) | | | | | |
| 300 ml | NH₄Cl: 10 g | HCl: 100 ml | H₂O₂: 40 ml | 45 to 50° C. | 6 hr |
| (specific | | | | | |
| gravity 1.05) | | | | | |
| 300 ml | NH₄Cl: 10 g | H₂SO₄: 100 ml | H₂O₂: 40 ml | 45 to 50° C. | 6 hr |
| (specific | | | | | |
| gravity 1.05) | | | | | |
| 300 ml | (NH₄)₂SO₄: | HNO₃: 100 ml | H₂O₂: 35 ml | 45 to 50° C. | 6 hr |
| (specific | 15 g | | | | |
| gravity 1.05) | | | | | |

### Example 3. Preparation of Tungstic Acid Fusion

A tungstic acid fusion was prepared in the same manner as in Example 1, except that the conditions were changed as shown in Table 3 below.

TABLE 3

| | | Acidic | | | |
|---|---|---|---|---|---|
| Tungstate | | solution | Dissolving agent | | |
| aqueous | | (substituting | (agglomerating | Reaction | Reaction |
| solution | Dispersant | agent) | agent) | temperature | time |
| 300 ml | NH₄Cl: 10 g | HNO₃: 100 ml | H₂O₂: 35 ml | 45 to 50° C. | 6 hr |
| (specific | | | | | |
| gravity 1.15) | | | | | |
| 300 ml | NH₄Cl: 10 g | HCl: 100 ml | H₂O₂: 35 ml | 45 to 50° C. | 6 hr |
| (specific | | | | | |
| gravity 1.15) | | | | | |
| 300 ml | NH₄Cl: 10 g | H₂SO₄: 100 ml | H₂O₂: 35 ml | 45 to 50° C. | 6 hr |
| (specific | | | | | |
| gravity 1.15) | | | | | |
| 300 ml | (NH₄)₂SO₄: 15 g | HNO₃: 100 ml | H₂O₂: 30 ml | 45 to 50° C. | 6 hr |
| (specific | | | | | |
| gravity 1.15) | | | | | |

### Experimental Example 1. Particle Shape SEM Analysis of Tungstic Acid Fusion

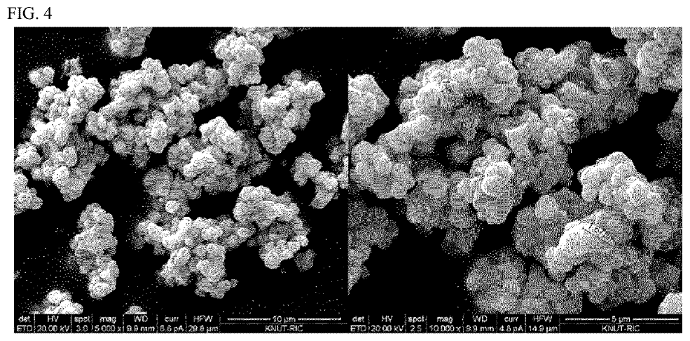

FIGS. 4 to 6 show SEM images of the tungstic acid fusions of Examples 1 to 3 prepared above.

Referring to FIG. 4, in the case of the tungstic acid fusion prepared according to Example 1, it may be seen that the shape of the primary particles is spherical, and the particles that are separated one by one are agglomerated in a grape-bunch shape.

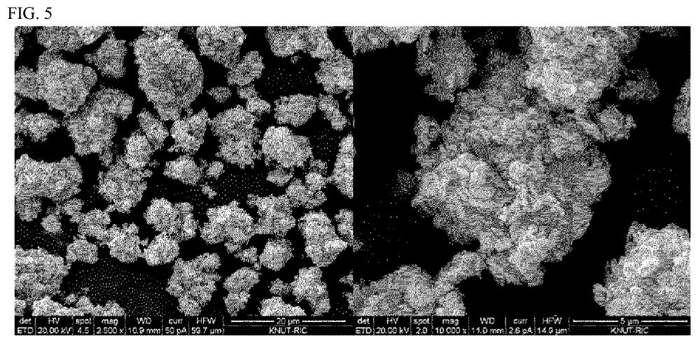

Referring to FIG. 5, in the case of the tungstic acid fusion prepared according to Example 2, it may be seen that the shape of the primary particles is acicular and has a relatively crystalline structure, and the acicular primary particles are agglomerated and spread.

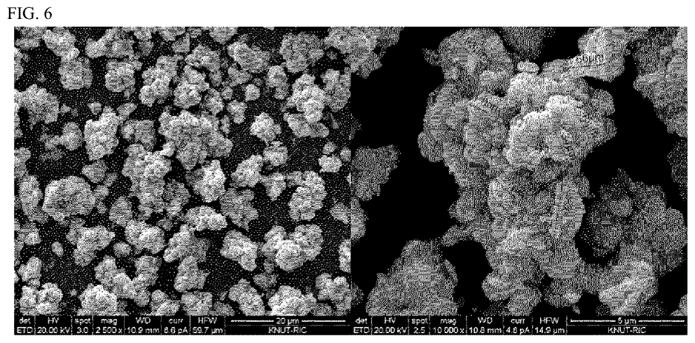

Referring to FIG. 6, in the case of the tungstic acid fusion prepared according to Example 2, it may be confirmed that the shape of the primary particles includes both spherical and acicular shapes, and the primary particles with high and low crystallinity are mixed, and it may be confirmed that the agglomerated shape is in the shape of particles with a grape-bunch-shaped structure.

### Experimental Example 2. XRD Peak Analysis of Tungstic Acid Fusion

The dried tungstic acid fusion powder prepared in Example was contained in a sample holder and compressed to flatten the surface to prepare a sample for XRD analysis. In addition, the sample was mounted on a high-resolution X-ray diffractometer (Bruker, D8 ADVANCE). The analysis conditions were set at a diffraction angle of 10° to 80°, a diffraction speed of 0.2 seconds, and a diffraction interval of 0.02 steps, and tungsten fusion XRD analysis was performed.

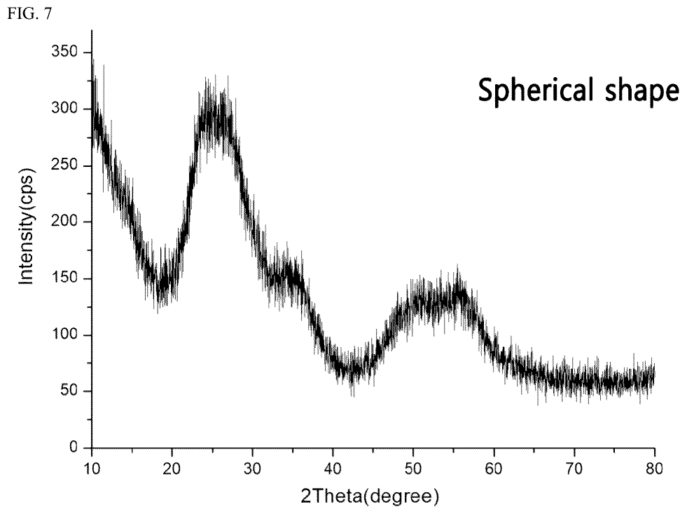

FIGS. 7 to 9 show XRD peak results of the tungstic acid fusions of Examples 1 to 3 prepared above, respectively. To interpret the peak results, the XRD-JCPDS CARD of WO₃·H₂O Tungstite was referenced, and as a result, in patterns calculated by an X-ray diffraction method, it was confirmed that main peaks at 2θ of about 16.53900 (hereinafter, referred to as a first peak), 25.6377° (hereinafter, referred to as a second peak), and 35.0352° (hereinafter, referred to as a third peak) were shown, and the intensities thereof were about 565.999, and 160, respectively.

Referring to FIG. 7, in the range of 16.5390±0.1° of 2θ, the peak corresponding to the first peak of WO₃·H₂O Tungstite hardly appeared, and accordingly, it was shown that a ratio of the corresponding peak intensity to the X-ray diffraction peak intensity of WO₃·H₂O may be formed at about 0.001 to 0.03. In addition, in the range of 25.6377±0.1°, the peak corresponding to the second peak of WO₃·H₂O Tungstite appeared weak, but a shift occurred or the peak was formed broadly, and accordingly, it was shown that the ratio of the corresponding peak intensity to the intensity of the X-ray diffraction peak of WO₃·H₂O may be formed at about 0.001 to 0.1. In addition, in the range of 35.0352±0.10, the peak corresponding to the third peak of WO₃·H₂O Tungstite appeared weak, but a shift occurred or the peak was formed broadly, and accordingly, it was shown that the ratio of the corresponding peak intensity to the intensity of the X-ray diffraction peak of WO₃·H₂O may be formed at about 0.001 to 0.1. Therefore, summarizing the results, it may be seen that the intensities of the main peaks were widely distributed rather than characteristically strong, which means that the crystallinity is relatively low and the crystal size is even. That is, when the shape of the primary particles of tungstic acid is spherical, it was shown that the crystallinity is low and the crystal size may be uniform.

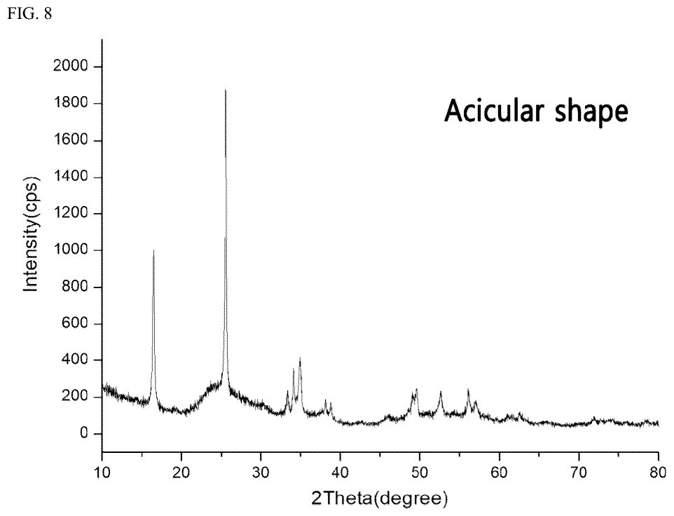

Referring to FIG. 8, in the range of 16.5390±0.1° of 2θ, the peak corresponding to the first peak of WO₃·H₂O Tungstite strongly appeared (intensity of 750 to 1100), and it was shown that the ratio of the corresponding peak intensity to the X-ray diffraction peak intensity of WO₃·H₂O may be formed at about 0.5 to 2.3. In addition, it could be seen that a full width at half maximum (FWHM) of the corresponding peak was 0.30° to 1.0°. In addition, in the range of 25.6377±0.10, the peak corresponding to the second peak of WO₃·H₂O Tungstite appeared strongly (intensity of 1350 to 1900), and accordingly, it was shown that the ratio of the corresponding peak intensity to the intensity of the X-ray diffraction peak of WO₃·H₂O may be formed at about 0.5 to 2.3. In addition, it could be seen that a full width at half maximum (FWHM) of the corresponding peak was 0.20° to 0.90°. In addition, in the range of 35.0352±0.10, the peak corresponding to the third peak of WO₃·H₂O Tungstite appeared (intensity of 300 to 450), and accordingly, it was shown that the ratio of the corresponding peak intensity to the intensity of the X-ray diffraction peak of WO₃·H₂O may be formed at about 0.5 to 1.3. In addition, it could be seen that a full width at half maximum (FWHM) of the corresponding peak was 0.300 to 1.10°.

In summary, it may be confirmed that the intensities of the main peaks are more characteristically stronger than that of WO₃·H₂O Tungstite, which indicates that a tungstic acid fusion having a relatively high crystallinity is formed when the shape of the primary particles of tungstic acid is only acicular.

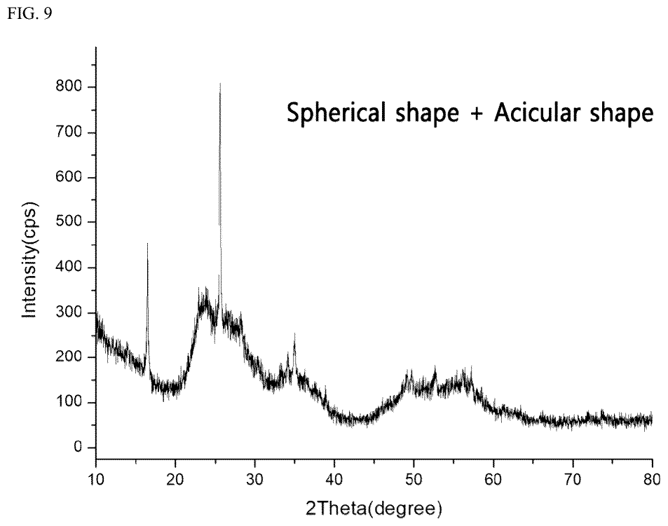

Referring to FIG. 9, in the range of 16.5390±0.1° of 2θ, the peak corresponding to the first peak of WO₃·H₂O Tungstite appeared somewhat strongly (intensity of 330 to 480), and it was shown that the ratio of the corresponding peak intensity to the X-ray diffraction peak intensity of WO₃·H₂O may be formed at about 0.5 to 1.2. In addition, it could be seen that a full width at half maximum (FWHM) of the corresponding peak was 0.30° to 1.0°. In addition, in the range of 25.6377±0.1°, the peak corresponding to the second peak of WO₃·H₂O Tungstite appeared somewhat strongly (intensity of 450 to 820), and accordingly, it was shown that the ratio of the corresponding peak intensity to the intensity of the X-ray diffraction peak of WO₃·H₂O may be formed to about 0.5 to 1.2. In addition, it could be seen that a full width at half maximum (FWHM) of the corresponding peak was 0.20° to 0.90°. In addition, in the range of 35.0352±0.10, the peak corresponding to the third peak of WO₃·H₂O Tungstite appeared (intensity of 200 to 290), and accordingly, it was shown that the ratio of the corresponding peak intensity to the intensity of the X-ray diffraction peak of WO₃·H₂O may be formed at about 0.5 to 1.3. In addition, it could be seen that a full width at half maximum (FWHM) of the corresponding peak was 0.30° to 1.10°. In summary, it was confirmed that the intensities of the main peaks were shown stronger at a certain level than that of WO₃·H₂O Tungstite, but the intensities appeared weak compared to Example 2, while the distribution of peaks was relatively widely distributed. This means that the shape of the primary particles of tungstic acid is a combination of acicular and spherical shapes, which means that parts with relatively good crystallinity and parts with poor crystallinity coexist.

### Experimental Example 3. Particle Size Distribution Analysis of Tungstic Acid Fusion

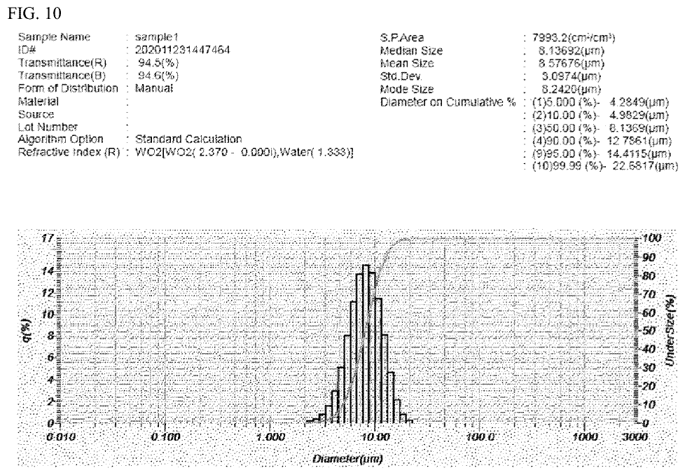

FIGS. 10 to 12 show particle size distribution analysis results of the tungstic acid fusions of Examples 1 to 3 prepared above, respectively.

Referring to FIG. 10, it was shown that D₅₀ of the amorphous tungstic acid fusion was about 8.13 μm and the standard deviation of the diameter of the amorphous tungstic acid fusion was about 3.10 μm, and it may be confirmed that when the shape of the primary particles of tungstic acid is spherical, the particle size of the tungstic acid fusion is formed relatively uniformly, and the size thereof may be well controlled to 30 μm or less.

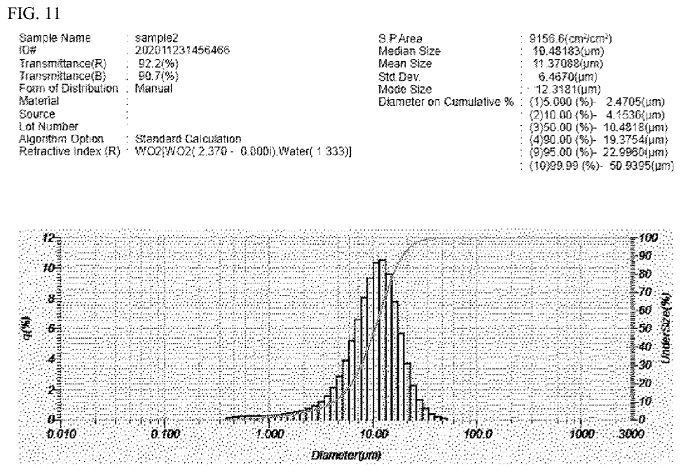

Referring to FIG. 11, it was shown that D₅₀ of the amorphous tungstic acid fusion was about 10.48 μm and the standard deviation of the diameter of the amorphous tungstic acid fusion was about 6.47 μm. As a result, it may be confirmed that when the shape of the primary particles of tungstic acid is acicular, as compared to Example 1, the D₅₀ and the standard deviation of the diameter were relatively large, but the particle size of the tungstic acid fusion is formed relatively uniformly, and the size thereof may be well controlled to 35 μm or less in the distribution of about 99% of the particles.

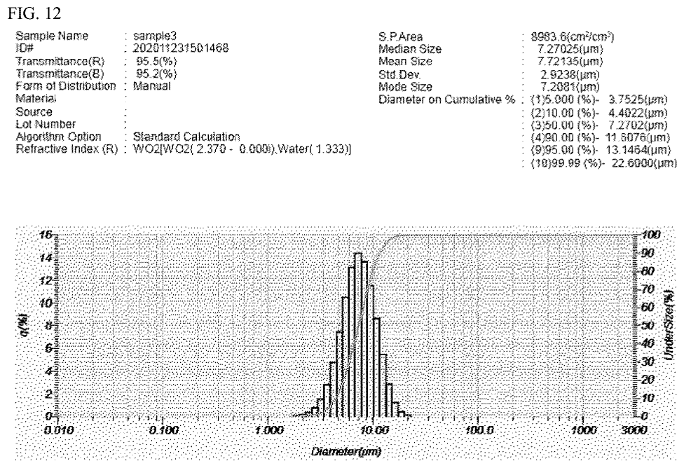

Referring to FIG. 12, it was shown that D₅₀ of the amorphous tungstic acid fusion was about 7.27 μm and the standard deviation of the diameter of the amorphous tungstic acid fusion was about 2.92 μm. As a result, it may be confirmed that when the shape of the primary particles of tungstic acid is a combination of acicular and spherical shapes, similarly to Example 1, the particle size of the tungstic acid fusion is formed relatively uniformly, and the size thereof may be well controlled to 30 μm or less.

### INDUSTRIAL APPLICABILITY

According to an embodiment of the present invention, it is possible to provide an eco-friendly and low-cost process technology that reduces process cost and significantly reduces air and water pollutant emissions by not performing an APT process.

In addition, according to an embodiment of the present invention, it is possible to provide a preparing process of a tungsten material that is easily commercialized without requiring the development of special equipment and devices.

1. An amorphous tungstic acid fusion formed by agglomerating primary particles of tungstic acid, wherein
the amorphous tungstic acid fusion has a grape-bunch-shaped structure formed therein as the primary particles of tungstic acid are interconnected.

2. The amorphous tungstic acid fusion of claim 1, wherein the shape of the primary particles of tungstic acid is spherical, acicular, or a combination thereof.

3. The amorphous tungstic acid fusion of claim 1, wherein the primary particles of tungstic acid are spherical particles having a diameter of 0.01 to 2.0 μm.

4. The amorphous tungstic acid fusion of claim 1, wherein the primary particles of tungstic acid are acicular particles having a length (L) of 0.01 to 1.8 μm, and
an aspect ratio (L/D) of 12 to 24.

5. The amorphous tungstic acid fusion of claim 1, wherein a diameter of the amorphous tungstic acid fusion is 30 μm or less.

6. The amorphous tungstic acid fusion of claim 1, wherein a D₅₀ of the amorphous tungstic acid fusion according to a particle size distribution measured by a laser diffraction scattering particle size distribution measuring method is 5 to 12 μm.

7. The amorphous tungstic acid fusion of claim 1, wherein a standard deviation of the diameter of the amorphous tungstic acid fusion is 1.5 to 7 μm.

8. The amorphous tungstic acid fusion of claim 1, wherein at least 80% or more of the primary particles of tungstic acid are agglomerated by fusion-binding at least 5 or more particles to each other.

9. The amorphous tungstic acid fusion of claim 2, wherein the primary particles of tungstic acid consist of acicular particles and spherical particles, and
the primary particles of tungstic acid have a ratio of (weight of acicular particles):(weight of spherical particles) of 1:0.3 to 3.

10. A method for preparing an amorphous tungstic acid fusion comprising:
adding a first additive containing an ammonium compound to a tungstate aqueous solution;
injecting an acidic solution into the tungstate aqueous solution; and
adding a second additive containing at least one of hydrogen peroxide and hydrofluoric acid to the aqueous solution, after injecting the acidic solution,
wherein a specific gravity of the tungstate aqueous solution is greater than 1.01 and less than 1.50, and 20 to 80 ml of the acidic solution is injected per 100 ml of the tungstate aqueous solution, 1 to 10 g of the first additive is added per 100 ml of the tungstate aqueous solution, 1 to 20 ml of the second additive is added per 100 ml of the tungstate aqueous solution,
the amorphous tungstic acid fusion has a grape-bunch-shaped structure in which the primary particles of tungstic acid are interconnected, and
the shape of the primary particles of tungstic acid is spherical, acicular, or a combination thereof.

11. The method for preparing the amorphous tungstic acid fusion of claim 10, wherein the shape of the primary particles of tungstic acid is acicular, or a combination of acicular or spherical shapes.

12. A tungsten oxide prepared by calcining the amorphous tungstic acid fusion powder according to claim 1.

13. A tungsten powder prepared by reducing the amorphous tungstic acid fusion powder according to claim 1.

14. A tungsten carbide powder prepared by carburizing the amorphous tungstic acid fusion powder according to claim 1.
